(19) United States
(12) Patent Application Publication
(10) Pub. No.: US 2002/0015026 A1
(43) Pub. Date: Feb. 7, 2002

(54) Focused line addressable electronic field visual display system and method

(76) Inventor: Jessica L. Stevens, San Mateo, CA (US)

Correspondence Address: TELEGEN CORPORATION, 1840 GATEWAY DRIVE, SUITE 200, SAN MATEO, CA, 94404, US

(21) Appl. No.: 09/851,762

(22) Filed: May 8, 2001

Related U.S. Application Data
(60) Provisional application No. 60/203,068, filed on May 9, 2000.

(51) Int. Cl. G09G 5/00

(52) U.S. Cl. 345/204

(57) ABSTRACT

A vacuum cathodoluminescent display device, also called a vacuum fluorescent display, with filamentary cathodes parallel to control gate wires and a matrix drive system utilizing anode based phosphor stripes adjacent and perpendicular to the control electrode gate wires, is introduced with tunable control electrode gate wire pairs via an unbalanced voltage drive which optimizes to the maximum the design and actual performance of the display device. Specifically, the tunable unbalanced control electrode voltage drive leads to the following decisive advantages over the prior art: 1) Increasing the efficiency of emission of electrons from the cathode 2) Efficiently bunching, guiding and focusing the electron stream emitted by the cathode into the activated gate and on to the assigned phosphor pixels 3) Avoiding electron interception and heating of active and inactive gate wires. 4) Avoiding electron termination into non-assigned phosphor pixels 5) Permitting low voltage, V≦100 volts and high voltage, V>100 volts, operation 6) Permitting the increase of the number of gates per filamentary cathode, thereby decreasing the number of cathodes and power consumption in the device 7) Minimizing the number of driver signals required to drive the gates, in the tunable unbalanced drive mode, to a number equal to half the gates in a cathode module.

There are two types of vacuum fluorescent displays: The first type, FIG. 1, where the cathode filaments are perpendicular to the gate wires, which has received wide commercial applications in small displays with anode voltages less than 100 volts. The second type, FIG. 2, where the cathode filaments are parallel to the gate wires, which has received very limited, if any, commercial application for reasons related to unsatisfactory performance compared to the perpendicular cathode/gate configuration. FIG. 3 shows a cross-section of the parallel cathode/gate configuration.

The two distinct vacuum fluorescent display devices shown in FIG. 1 and FIGS. 2 and 3 include the following common elements: A glass backplane 1, with a thin 5, conducting layer facing the evacuated interior of the display, and forming part of the vacuum enclosure of the display. A bias voltage is applied on the thin 5, conducting layer in order to control the electron current emitted by the filamemtary cathode 2. The filamentary cathodes 2 are periodically spaced and supported at the lateral edges of the display envelope by springs.

The mechanism of emission is thermionic emission, the temperature of the cathode tungsten filament having been raised to several hundred degrees by the flow of a filament current driven by a low filament voltage applied at the structurally supported ends of the cathode wire.

Control electrodes or gate wires 3, are tensioned and attached to holding structures embedded at the two lateral edges of the interior vacuum envelope of the display. Each of the control electrodes 3, is connected, at one end thereof, to an electrode terminal at the lateral edge of the display, which in turn is connected to an external electronic driver circuit.

A pair of adjacent control electrodes when biased with the proper bias voltage constitutes an electron accelerating and focusing gate, pulling thermionic electrons boiled off the surface of the filamentary cathode, while all the remaining control electrodes, biased with zero or negative voltage act as electron blocking gates.

Accelerated and focused electrons passing the plane of the active gate are further accelerated, by the anode voltage, and impact the segment of the phosphor stripe 4, under the open gate, which constitutes a pixel. The phosphor stripes 4, are deposited on top of thin conducting stripes 6, said conducting stripes constituting the anode electrode where the anode potential is applied. The thin conducting stripes are deposited on a glass surface which constitutes the outer vacuum envelope of the display. The thin conducting stripes with the phosphor deposited on top of them are separated by insulating glass stripes which are part of the envelope glass vacuum enclosure.

The vacuum cathodoluminescent display thus constructed is driven by applying a display signal to each of the anode electrodes 5, while at the same time energizing a pair of adjacent control electrodes 3, to form an active gate, which causes the thus selected phosphor cells, or pixels, to emit light so as to effect a desired programmed display.

Operation of the vacuum cathodoluminescent display device will be described in detail, via FIG. 4, which shows a generic drive circuit for the parallel cathode/gate configuration of FIGS. 2, 3, 5 and 7 as well as the perpendicular cathode/gate configuration of FIGS. 1 and 6.

In FIG. 4, control electrodes of odd number C1, C3, C5 . . . are connected to one control electrode drive circuit, DC1, and control electrodes of even number C2, C4 . . . are connected to another control electrode drive circuit, DC2. The control electrode drive circuits DC1 and DC2 may be constructed in a manner known in the art.

FIG. 5(a) is a standard timing chart of the circuit shown in FIG. 4 for both the perpendicular cathode/gate, FIG. 1, and parallel cathode/gate, FIG. 2, configurations.

It is well recognized in the field that display configuration with the perpendicular cathode/gate geometry work very well for the intended applications and they are very robust as far as their design is concerned. On the other hand display configurations of the parallel cathode/gate geometry have not been used at all in practice because of a very serious drawback. Namely the distance of the gate-wire pair varies significantly from the cathode filament, thereby resulting in very uneven electron current illumination of the pixels as one varies the gate location on the face of the display. This effect is enhanced the closer the cathode is to the gate plane, to the point that the outermost gates in a cathode/gate module do not draw any electron current at all because of the substantial increase in their distance to the cathode as compared to the gate nearest the cathode.

In the present invention, shown by example in FIG. 5(b), we introduce and use the principle of tuning each gate by means of an unbalanced gate voltage drive, as shown in FIG. 5(b), in order to optimize the electron current generated and transmitted by the cathode through the assigned gate to the assigned pixel on the anode, as shown in FIGS. 8(a) and 8(b). For design purposes this is accomplished via 3-dimensional computer simulation of electron trajectories or via a test drive apparatus in an actual display device.

Before proceeding with the detailed description of the present invention and its preferred embodiments we return briefly to the prior art in order to establish further the novel aspects of the present invention.

In U.S. Pat. No. 4,868,555, dated Sep. 19, 1989, Hiroshi Watanabe et al introduce the concept of the unbalanced drive for a perpendicular cathode/gate display geometry, see FIGS. 6(a), 6(b), and 6(c), in order to be able to drive a plurality of pixels by a single pair of control electrodes (one gate). In our computer simulation studies we sought to simulate the above objective with extremely small success, if any.

In U.S. Pat. No. 5,055,744, dated Oct. 8, 1991, Yoshihisa Tsuruoka used the concept of the unbalanced drive for a parallel cathode/gate display geometry, see FIGS. 7(a), 7(b), and 7(c), in order, again, to be able to drive a plurality of pixels by a single pair of control electrodes (one gate). The control and bending of the electron stream was postulated to happen in the physical space between the plane of the gates and the anode plane, near the phosphor surface. An integral part of this invention appeared to be the cathode location very close to the plane of the gates, which constitutes a very severe design limitation.

The invention presented for the first time here differs fundamentally from the concepts and objectives of the prior art depicted in FIGS. 5(a), 6(a-c) and 7(a-c), which fail to optimize the electron current impacting a given pixel through its driving gate.

### SUMMARY OF THE INVENTION

The present invention has been made in view of the foregoing disadvantages of the prior art.

Accordingly, it is an object of the present invention to provide a cathodoluminescent display device of the parallel cathode/gate geometry which is simple in structure and works for a large number of gates per cathode module.

It is another object of the present invention to produce a cathodoluminescent display device which exhibits high resolution and high luminance, in a reduced thermal dissipation device environment.

The present invention comprises a vacuum cathodoluminescent display method comprising the steps of retrieving an ordered pair of gate wire voltages according to a row of pixels to be driven according to a video signal; and biasing a pair of gate wires according to the retrieved ordered pair of gate wire voltages, wherein the retrieved ordered pair of gate wire voltages are prestored in order to compensate for gate wire distance from a filament.

### BRIEF DESCRIPTION OF THE DRAWINGS

FIG. 1 shows a display where the cathode filaments are perpendicular to the gate wires. This configuration has received wide commercial applications in small displays with anode voltages less than 100 volts.

FIG. 2 shows a display where the cathode filaments are parallel to the gate wires. This configuration has received very limited, if any, commercial application for reasons related to unsatisfactory performance compared to the perpendicular cathode/gate configuration shown in FIGURE.

FIG. 3 shows a cross-section of the parallel cathode/gate configuration as described in FIG. 2.

FIG. 4 shows a generic drive circuit used in the parallel cathode/gate configuration display shown in FIGS. 1 and 2.

FIG. 5(a) shows a standard timing chart of the circuit shown in FIG. 4 for both the perpendicular cathode/gate configuration as shown in FIG. 1 and the parallel cathode/gate configuration as shown in FIG. 2.

FIG. 5(b) shows the timing chart using the principle of tuning each gate by means of an unbalanced gate voltage drive.

FIGS. 6(a), 6(b), and 6(c) show the concept of the unbalanced drive for a perpendicular cathode/gate display geometry as embodied in U.S. Pat. No. 4,868,555.

FIGS. 7(a), 7(b), and 7(c) show another concept of the unbalanced drive for a parallel cathode/gate display geometry as embodied in U.S. Pat. No. 5,055,744.

FIG. 8(a) shows electron trajectories for a gate with the conventional voltage drive shown in FIG. 5(a).

FIG. 8(b) shows electron trajectories for a gate without electron interception of the gate wires, by following the tuning procedure of the unbalanced gate voltage drive of FIG. 5(b).

FIG. 9 shows an alternative the tuned gate via unbalanced voltage drives in which the cathode is located much closer to the gate plane.

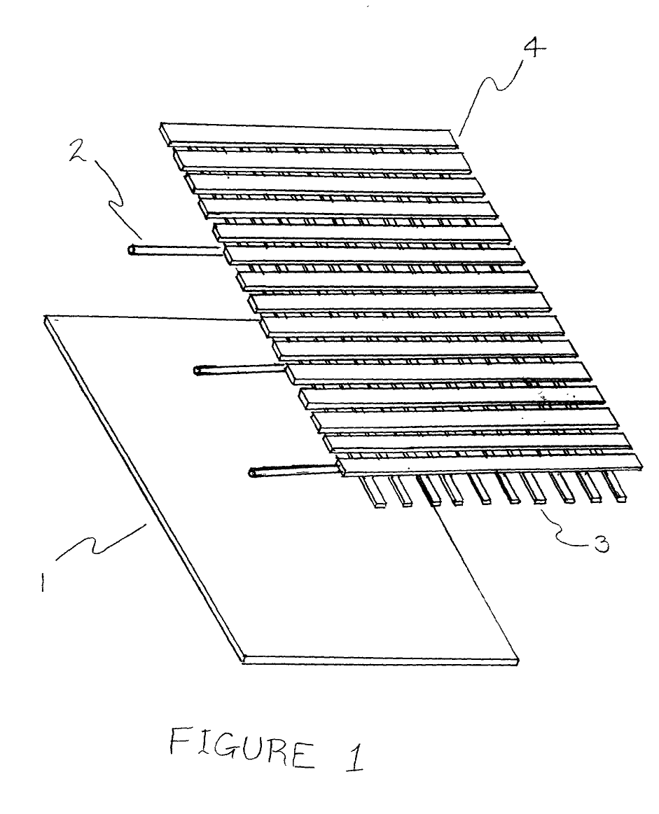

### DETAILED DESCRIPTION OF THE PREFERRED EMBODIMENT

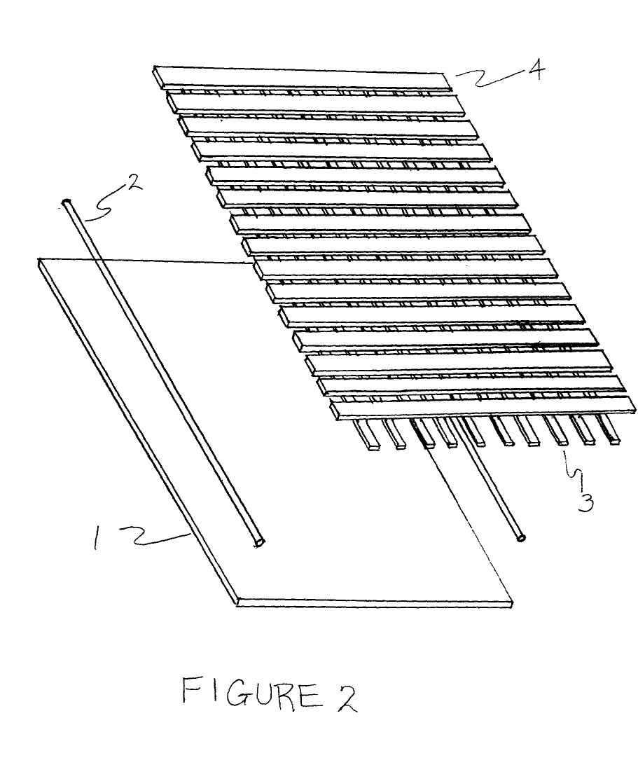

Now, a vacuum cathodoluminescent display device according to the present invention will be described with reference to FIGS. 2, 3, 4, 5, 8 and 9.

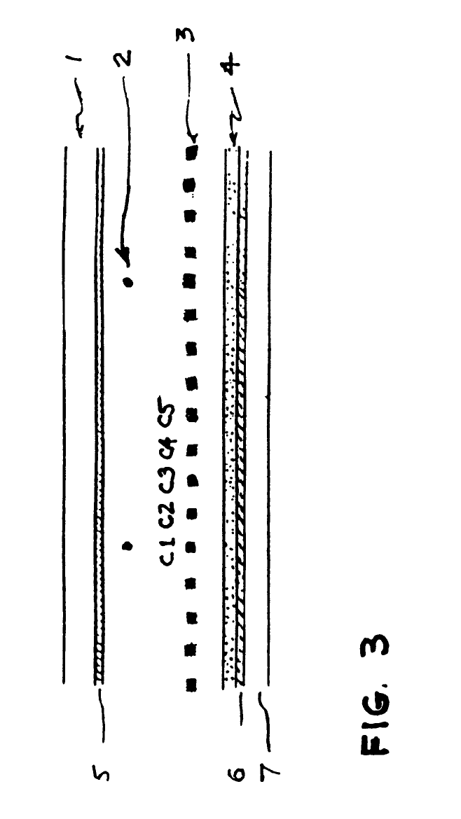

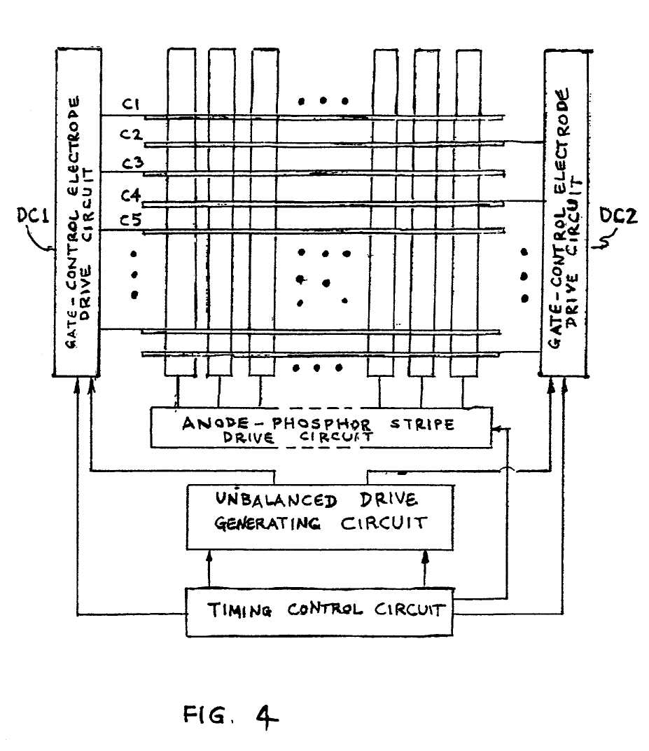

FIGS. 2 and 3 are 3-dimensional and 2-dimensional views respectively showing a general structure of a parallel cathode/gate vacuum cathodoluminescent display device, according to the present invention, wherein the same reference numerals indicate corresponding parts. The electrical drive connections are shown and labeled in FIG. 4.

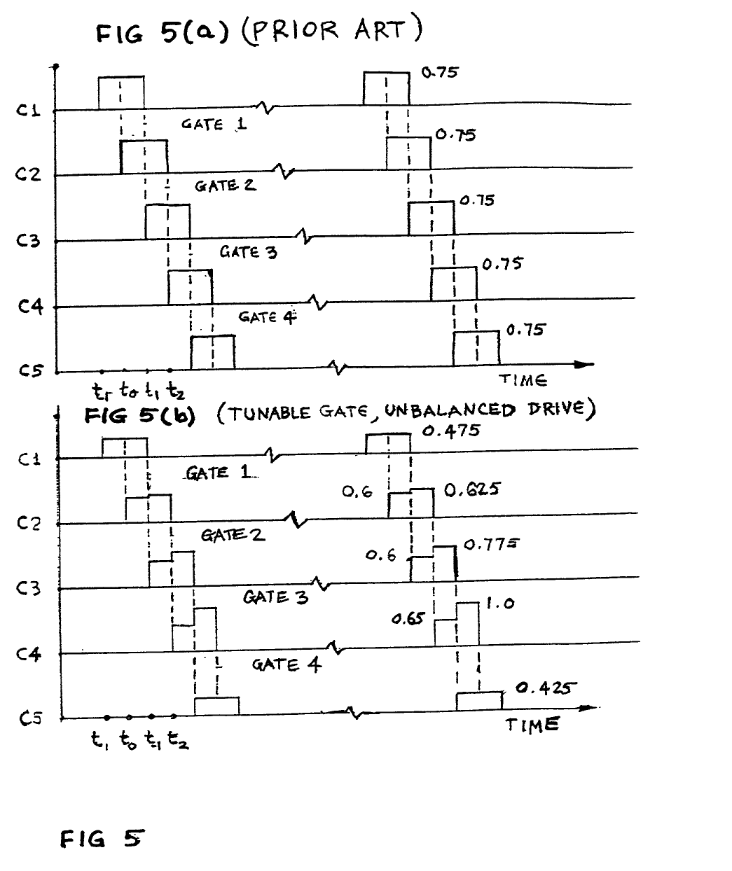

The sequence of applied electrical drive signals to the gate wires, so labeled in FIGS. 3 and 4, is shown in FIG. 5, which is the essence of the invention as detailed in FIG. 5(b). In the conventional prior art, as shown in FIG. 5(a), each gate wire is driven by an identical voltage signal. Given the progressive increase of the distance of the gate wire from the cathode filament, as measured from the cathode-gate axis shown in FIG. 3, then it follows that the current collected through each gate will decrease as the distance of the gate increases from the cathode-gate axis.

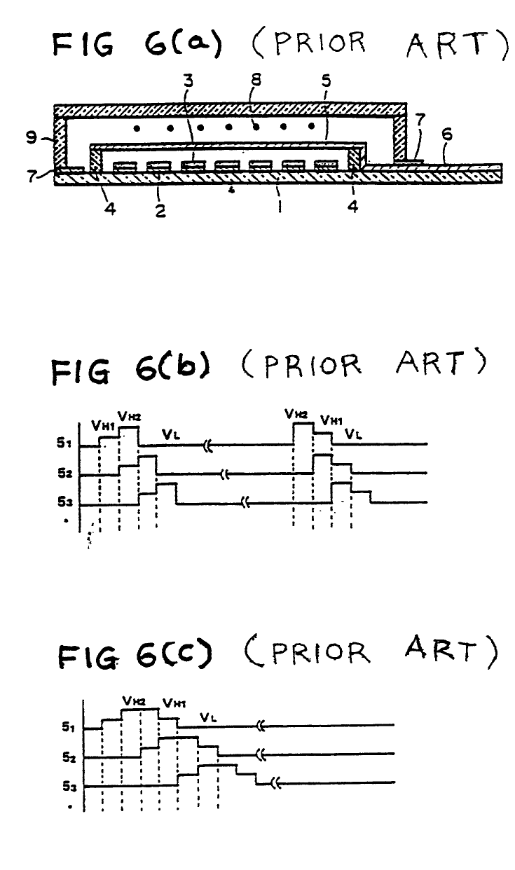

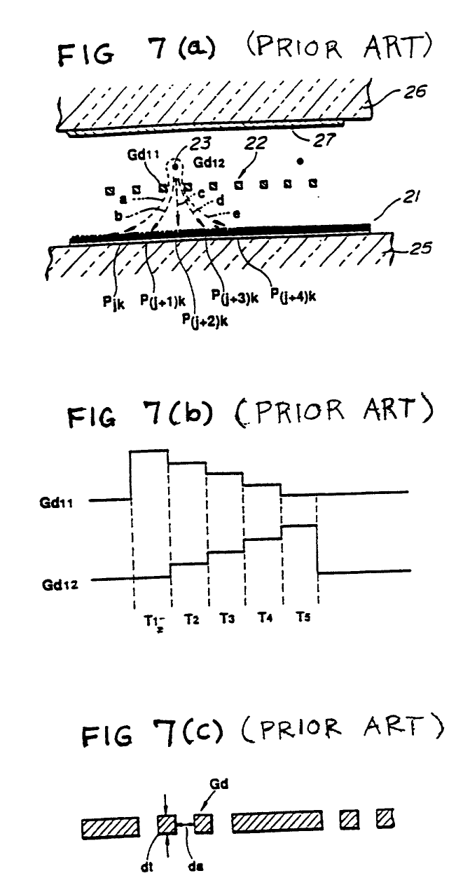

This is also an inherent problem in the prior art of FIGS. 6(a), (b), (c) and 7(a), (b), (c) where the gate voltage does vary with the distance of the gate from the cathode-gate axis. In this invention the voltage applied on the gate wires is varied with distance from the cathode/gate axis as shown in detail in FIG. 5(b). For the gate wire (C1), underneath the cathode the applied voltage is reduced (0.475), compared to the reference value (0.75), because of the proximity to the cathode filament. The adjacent gate wire (C2), forming gate 1 when driven together with gate wire (C1), is driven to a higher voltage (0.6), when compared to gate wire C1, but lower voltage when compared to the reference value (0.75). For gate number 2, located further away from the cathode/gate axis, and composed of gate wires C2 and C3, the driver voltages are 0.625 and 0.6 respectively. For gate number 3, composed of gate wires C3 and C4, the driver voltages are 0.775 and 0.65 respectively. For gate number 4, the last gate in the indicated cathode module, composed of gate wires C4 and C5, the driver voltages are 1.0 and 0.425.

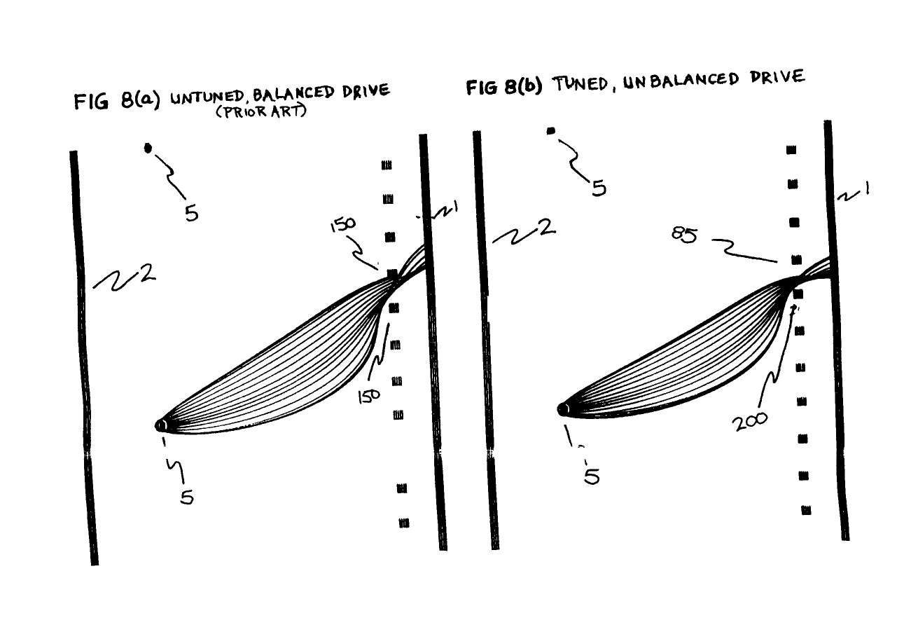

The values for the voltages given here and in FIG. 5(b) are the ratios of the actual gate voltages divided by the constant anode voltage. In the computer simulation the anode voltage was 200 Volts, as predicated by the larger distance of the cathode filament from the plane of the gates as shown in FIGS. 8(a, b). The value of the two voltages for each gate is adjusted individually for each gate so as to optimize the current pulled by the gate from the cathode as well as to optimize the uniformity of impact of the electron stream on the phosphor pixel spanned by the given gate, while at the same time minimizing the interception of stream electrons by the gate wires.

For the bulk of the gates (3 out of 4) this is accomplished by having the gate wire nearest the cathode at higher voltage compared to the gate wire further away. For the gate nearest the cathode the opposite is found to be true. The gate wire nearest the cathode has the lower voltage. It is thus observed that each gate is individually tuned to the best possible performance via the asymmetric, unbalanced voltage drive of the two gate wires. This need be done only once, for half a module and then repeated in mirror images on either side beyond the half module. The gate tuning can be done either with a computer simulation or an experimental test driver or both. FIGS. 8(a) and 8(b) illustrates actual electron trajectories observed for the example of FIGS. 5(a) and 5(b). Namely FIG. 8(a) shows electron trajectories for gate 4 with the conventional voltage drive shown in FIG. 5(a).

It is seen that the electron stream lands in a phosphor pixel beyond the one it should go to, and that a significant number of electrons intercepts the gate wire C4, an altogether unacceptable performance, very characteristic of the parallel cathode/gate configuration especially for gates far off the cathode/gate axis. In contrast, FIG. 8(b) shows a very well behaved electron stream, impacting its intended phosphor pixel, without electron interception of the gate wires, by following the tuning procedure of the unbalanced gate voltage drive of FIG. 5(b) for gate 4. Further fine-tuning is also possible, but not shown here.

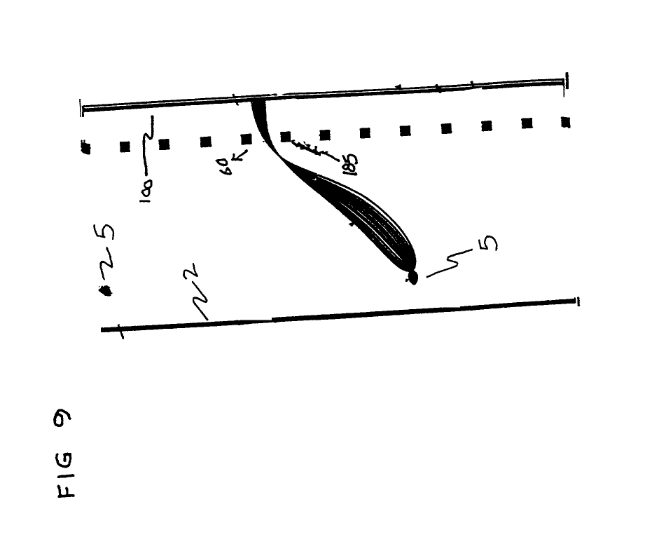

Another example of the tuned gate via unbalanced voltage drives is shown in FIG. 9. In this case the cathode is located much closer to the gate plane, which results in much larger relative variation in the distance from the cathode to the gate along the gate plane. Specifically when gate 4 in FIG. 9 is driven in the conventional mode (Vₐ=100 Volts, V_{b}=75 Volts), then there is no current through the gate. When the tuned gate via unbalanced voltage drive principle is used there is good current through the center of the gate. (V₄=1.85, V₅=0.6). The degree of voltage imbalance in the gate drive has increased here compared to the case of FIGS. 5(b) and 8(b).

We claim:

1. A vacuum cathodoluminescent display method comprising:
retrieving an ordered pair of gate wire voltages according to a row of pixels to be driven according to a video signal; and
biasing a pair of gate wires according to the retrieved ordered pair of gate wire voltages, wherein the retrieved ordered pair of gate wire voltages are prestored in order to compensate for gate wire distance from a filament.
